(19) United States
(12) Patent Application Publication
(10) Pub. No.: US 2024/0416163 A1
(43) Pub. Date: Dec. 19, 2024

(54) FIRE PREVENTION IN VEHICLE BATTERIES USING OXYGEN REDUCTION

(71) Applicant: TOYOTA MOTOR ENGINEERING & MANUFACTURING NORTH AMERICA, INC., Plano, TX (US)

(72) Inventors: Tenghua T. Shieh, Ann Arbor, MI (US); Utsav Raj Aryal, Ypsilanti, MI (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/319,021

(22) Filed: Jun. 14, 2023

(51) Int. Cl. A62C 3/07; A62C 3/16; A62C 37/36; A62C 99/00; B60L 3/00

(52) U.S. Cl. CPC A62C 3/07; A62C 3/16; A62C 37/04; A62C 99/0018; B60L 3/0046

(57) ABSTRACT

A system and method to prevent fires in electric vehicles. The system reduces thermal runaway in vehicle battery pack by controlling nitrogen-enriched air (“NEA”) to a predetermined oxygen concentration to prevent fires and/or explosions in battery packs. The oxygen content of an electric vehicle battery pack is detected using an oxygen sensor. A controller determines whether the oxygen content exceeds a predetermined threshold. Based upon this determination, electrochemical gas separation and inerting system is activated to generate NEA. The system delivers the NEA to the battery pack until the oxygen content no longer exceeds the predetermined threshold.

### FIELD OF THE DISCLOSURE

The present disclosure relates generally to vehicle systems and, more particularly, to systems to reduce thermal runaway in vehicle battery packs using oxygen reduction, thereby preventing battery fires.

### BACKGROUND

Thermal runaway occurs when a battery cell short circuits and/or otherwise starts to heat up uncontrollably. Such an event can occur in vehicle electric batteries for a number of reasons such as due to debris intrusion, manufacturing defects, short circuits, or extreme/long durations of high heat and fast charging in battery packs. Fires may ignite in many circumstances including while the vehicle is parked, post-crash and while being charged or driven.

Conventional mitigation techniques have many disadvantages. To date, the mitigation techniques have been based on cooling system enhancements, insulation, fire barriers or battery material innovation-all means by which to deal with a fire after it has already ignited. However, it is very difficult to put out a vehicle battery fire once it has already started.

### SUMMARY

In consideration of the above-described disadvantages, the present disclosure provides computer-implemented systems and methods to prevent fires in electric vehicles. To do so, the system reduces thermal runaway in vehicle battery pack by controlling nitrogen-enriched air (“NEA”) to a predetermined oxygen concentration to prevent fires and/or explosions in battery packs. In a generalized embodiment, the oxygen content of an electric vehicle battery pack is detected using an oxygen sensor. A controller (processing circuitry) determines whether the oxygen content exceeds a predetermined threshold. Based upon this determination, electrochemical battery inerting system (“ELBIS”) is activated to generate NEA. The system then delivers the NEA to the battery pack until the oxygen content no longer exceeds the predetermined threshold, thereby preventing a fire from being ignited within the battery pack.

In another illustrative embodiment, a fire-prevention system for an electric vehicle includes a controller and oxygen sensor communicably coupled to the controller to detect an oxygen content of the vehicle battery pack. An ELBIS is also included in the system to generate NEA nitrogen-enriched air in response to the controller's determination of whether the oxygen content exceeds a predetermined threshold. Thereafter, the ELBIS continues to deliver the NEA to the battery pack until the oxygen content no longer exceeds the predetermined threshold, thereby preventing a fire from being ignited within the batter pack.

In yet another illustrative embodiment, an electric vehicle includes a battery pack, controller and oxygen sensor communicably coupled to the controller to detect an oxygen content of the battery pack. The vehicle also includes an ELBIS that generates NEA in response to a determination, by the controller, the oxygen content exceeds a predetermined threshold. The ELBIS then delivers the NEA to the battery pack until the oxygen content no longer exceeds the predetermined threshold, thereby preventing a fire from being ignited within the battery pack. The vehicle also includes an air dryer to capture and recirculate water vapor, thereby humidifying the NEA before it is delivered to the battery pack.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a diagrammatic illustration, in block diagram form, of a vehicular system according to certain illustrative embodiments of the present disclosure.

FIG. 2A is a block diagram of a fire-prevention system, according to certain illustrative embodiments of the present disclosure.

FIG. 2B is a graph showing the ignition delay time with respect to the mixture temperature.

FIG. 2C is a graph showing the ignition time delay with respect to the mixture Lambda.

FIG. 2D is a graph showing the ignition time delay with respect to the actual oxygen fraction in the mixture.

FIG. 3 is a more detailed block diagram of a fire-prevention system, according to certain illustrative embodiments of the present disclosure.

FIG. 4 is a flow chart of a fire-prevention method for an electric vehicle, according to certain illustrative methods of the present disclosure.

### DESCRIPTION OF ILLUSTRATIVE EMBODIMENTS

Illustrative embodiments and related methods of the present disclosure are described below as they might be employed in systems and methods to prevent fires in electric vehicle battery packs. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, the present disclosure describes methods and systems to prevent fires from igniting in electric vehicle batteries. The presence of a certain concentration of oxygen is necessary for fires/explosions to ignite. In order to prevent this environment, the system uses an electrochemical battery inerting system (“ELBIS”) based on a fuel cell to produce and supply nitrogen-enriched air (“NEA”) in order to reduce the oxygen concentration in the system. In particular, a polymer electrolyte membrane (PEM) fuel cell with a PEM electrolyzer generates humidified NEA from the cathode output. The NEA may then be dehumidified and supplied directly to the battery pack. The required rate of NEA varies and, through the ELBIS, the rate of NEA generation can be controlled by varying the current with a constant voltage power supply applied to the system.

In a generalized embodiment, an illustrative system of the present disclosure may include a controller is communicably coupled to processing circuitry (a controller), oxygen system and an ELBIS. The oxygen system detects the oxygen content of an electric vehicle battery pack. The ELBIS then activates and generates NEA once the controller determines the oxygen content of the battery pack exceeds a predetermined threshold. In some embodiments, the predetermined threshold is a 9% oxygen content, a 5% oxygen content or a 5-9% oxygen content. The ELBIS continues to deliver the NEA to the battery pack until the oxygen content no longer exceeds the threshold, thereby preventing a fire from every being ignited within the battery pack.

In other embodiments, the system also includes an air dryer to capture and recirculate water vapor of the ELBIS to thereby dehumidify the NEA before it is delivered to the battery pack. In certain embodiments, the air dryer may be a silicone membrane air dryer or some other suitable air dryer. In yet other embodiments, the oxygen sensors may be located near an inlet or outlet of the battery pack.

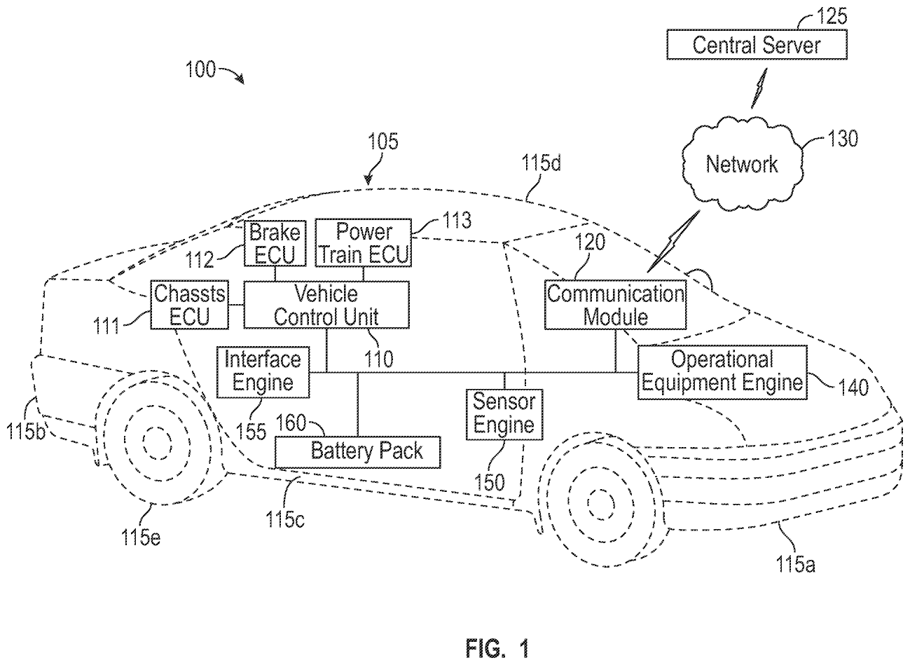

FIG. 1 is a diagrammatic illustration of a system to prevent electric vehicle battery fires in accordance with certain illustrative embodiments of the present disclosure. In an example, a fire-prevention system is referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, or the like). The central server 125 may provide information and services including but not limited to include location, mapping, route or path, and topography information.

An operational equipment engine 140 is operably coupled to, and adapted to be in communication with, the vehicle control unit 110. A sensor engine 150 is operably coupled to, and adapted to be in communication with, the vehicle control unit 110. The sensor engine 150 is adapted to monitor various components of, for example, the operational equipment engine 140, as will be described in further detail below. An interface engine 155 is operably coupled to, and adapted to be in communication with, the vehicle control unit 110. In addition to, or instead of, being operably coupled to, and adapted to be in communication with, the vehicle control unit 110, the communication module 120, the operational equipment engine 140, the sensor engine 150, and/or the interface engine 155 may be operably coupled to, and adapted to be in communication with, another of the components via wired or wireless communication (e.g., via an in-vehicle network). In some examples, the vehicle control unit 110 is adapted to communicate with the communication module 120, the operational equipment engine 140, the sensor engine 150, and the interface engine 155 to at least partially control the interaction of data with and between the various components of the fire-prevention system 100.

The term “engine” is meant herein to refer to an agent, instrument, or combination of either, or both, agents and instruments that may be associated to serve a purpose or accomplish a task—agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with any or all of the vehicle control unit 110, the communication module 120, the network 130, or a central server 125.

In this example, the vehicle 105 also includes a chassis electronic control unit (ECU) 111 which controls elements of the vehicle's suspension system, a brake ECU 112 which controls the braking system or elements thereof, a power train ECU 113 (variously known as an engine ECU, power plant ECU, motor ECU, or transmission ECU) that controls elements of the motor (not shown) and drivetrain (not shown), and sensor engine 150, and vehicle battery pack 160, as will be described in more detail below.

A reader of ordinary skill in the art will understand that other components or arrangements of components may be found in a vehicle 105, and that the same general principles apply to electric vehicles, internal combustion vehicles, and hybrid vehicles. For example, a power train ECU 113 may control both motor and transmission components. Alternatively, a separate motor ECU and transmission ECU may exist, or some functions of a motor ECU or transmission ECU may be performed by the VCU 110.

In some examples, the operational equipment engine 140, which is operably coupled to, and adapted to be in communication with, the vehicle control unit 110, includes a plurality of devices configured to facilitate driving of the vehicle 105. In this regard, the operational equipment engine 140 may be designed to exchange communication with the vehicle control unit 110, so as to not only receive instructions, but to provide information on the operation of the operational equipment engine 140. For example, the operational equipment engine 140 may be communicably coupled to vehicle battery 160, a motor, drivetrain, steering system, braking system, etc.

In some vehicles, the vehicle battery 160 may provide electrical power to the motor to drive the wheels 115e of the vehicle 105 via the drivetrain. In some examples, instead of or in addition to providing power to the motor to drive the wheels 115e of the vehicle 105 via the drivetrain or transmission, the vehicle battery 160 provides electrical power to another component of the operational equipment engine 140, the vehicle control unit 110, the communication module 120, the sensor engine 150, the interface engine 155, or any combination thereof.

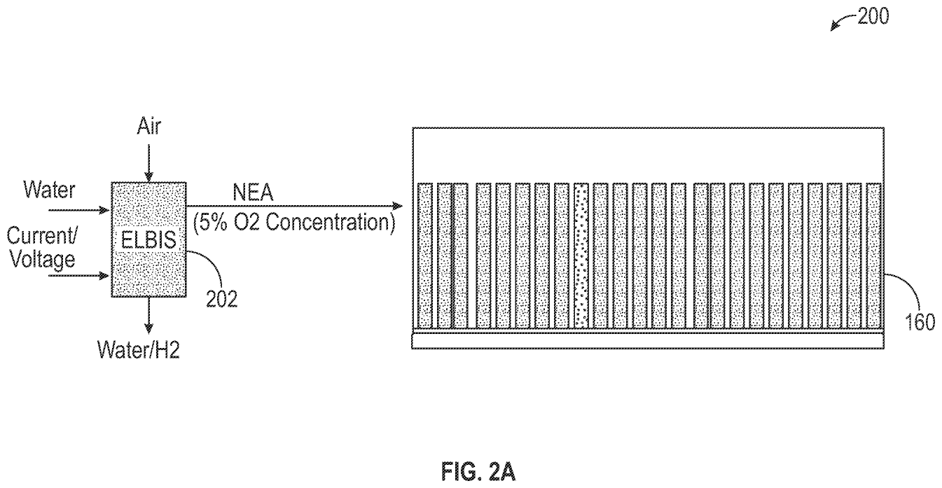

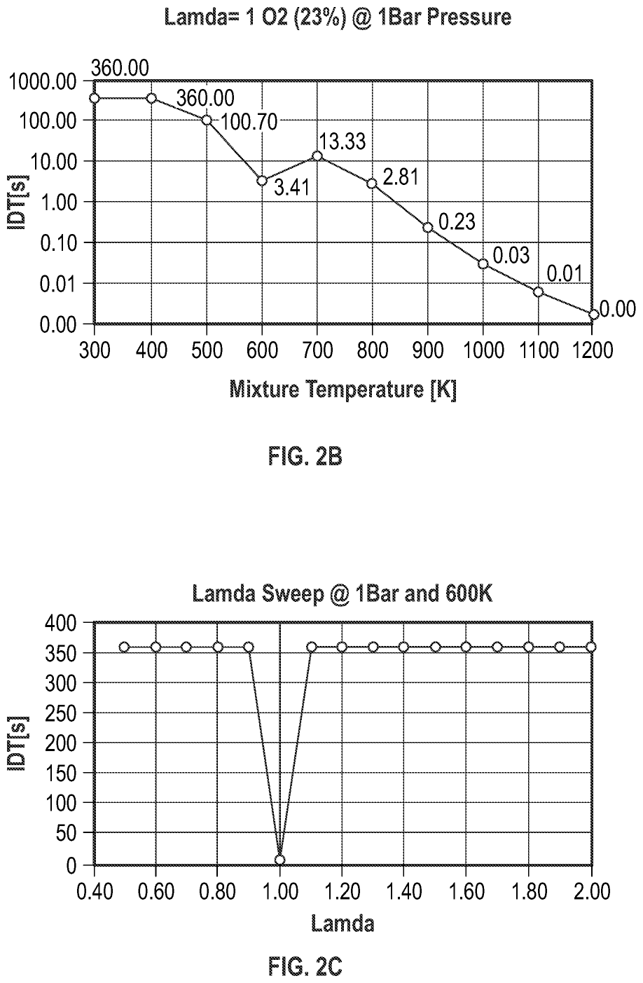

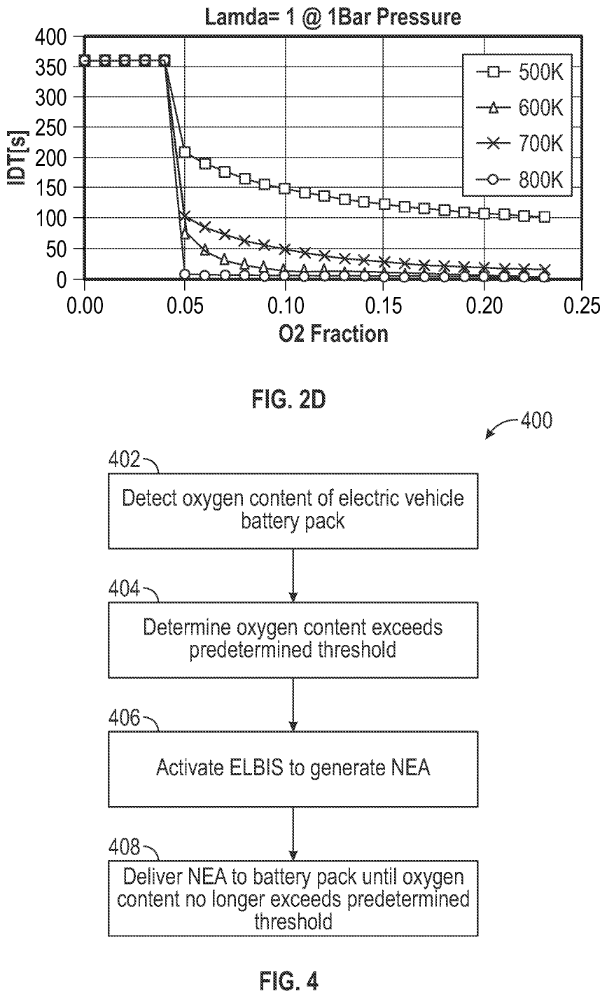

FIG. 2A is a block diagram of a fire-prevention system, according to certain illustrative embodiments of the present disclosure. Fire-prevention system 200 is intended to illustrate the fundamental operation of the present disclosure. Fire-prevention system 200 includes an ELBIS 202 and battery pack 160. ELBIS 202 is a combination of a proton exchange member fuel cell (“PEMFC”) and electrolyzer. Although not shown, ELBIS 202 includes an anode, cathode and membrane electrolyte assembly (“MEA”), as will be understood by those ordinarily skilled in the art. In certain embodiments, ELBIS 202 initially fills the interior volume of battery pack 160 with NEA. As such, system 200 replaces air in the volume (interior of battery pack 160) without a volume change. ELBIS 202 generates NEA to control the internal environment of battery pack 160 to thereby prevent battery pack 160 from ever entering a state conducive to fires. Air, water and current/voltage are provided to ELBIS 202 to enable the generation of NEA at a 5% oxygen concentration. However, in alternative embodiments different oxygen concentrations may be used, as discussed herein.

Water and, in some embodiments, hydrogen is created by ELBIS 202 as a by-product and may be captured and recirculated by a water recovery system, as will be described below. Ultimately, the NEA having the desired oxygen concentration is delivered to the interior of battery pack 160. The vapor/air inside battery pack 160 is ultimately vented out (exits), where the oxygen content is also monitored by Fire-prevention system 200 in order to maintain the oxygen content of the vapor inside battery pack 160 within a desired range.

FIGS. 2B-2D are graphs illustrating how the system generates NEA to feed the interior of the battery pack. In these simulated examples, the following assumptions were made: iso-Octane fuel was used to represent the electrolyte vapor of the battery pack interior, air includes N₂ and O₂, and 1 bar of pressure is assumed within the battery pack volume. Further, the air mixture is substantially at a stoichiometry condition, meaning the amount of oxygen is not more than the amount of oxygen required for the chemical reaction. The mixture temperature was greater 500 K (FIG. 2B). Lastly, the O₂ content was greater than 5% (FIG. 2D).

FIG. 2B is a chart reflecting the study of mixture combustibility by simulation with the oxygen content at 23%. Here, the condition of Lamda=1 is shown (which is considered the easiest condition for combustion to occur). The simulation is set to stop at 360 seconds. If the ignition for the combustion process doesn't happen, we will consider that combustion will not occur after 360 seconds. The X-axis is the mixture temperature (FIG. 2B) and y-axis is the ignition-delay time (IDT) in seconds. IDT is the indication of how quick the combustion will ignite at the corresponding condition of mixture at a given Lamda, pressure and temperature. In FIG. 2C, the pressure was set at 1 bar because the air inside the pack should be similar to the ambient level. In FIG. 2D plots the O₂ level in the mixture of Lamda=1. A smaller O₂ fraction means there is more N₂ in the air. The IDT is plotted as a function of O₂ fraction in the air. It is clear to see when the O₂ fraction is dropped to less than 5%, the combustion will never occur (the IDT is longer than 360 seconds) no matter the mixture temperature. Usually, the higher the mixture temperature, the easier for the combustion to occur.

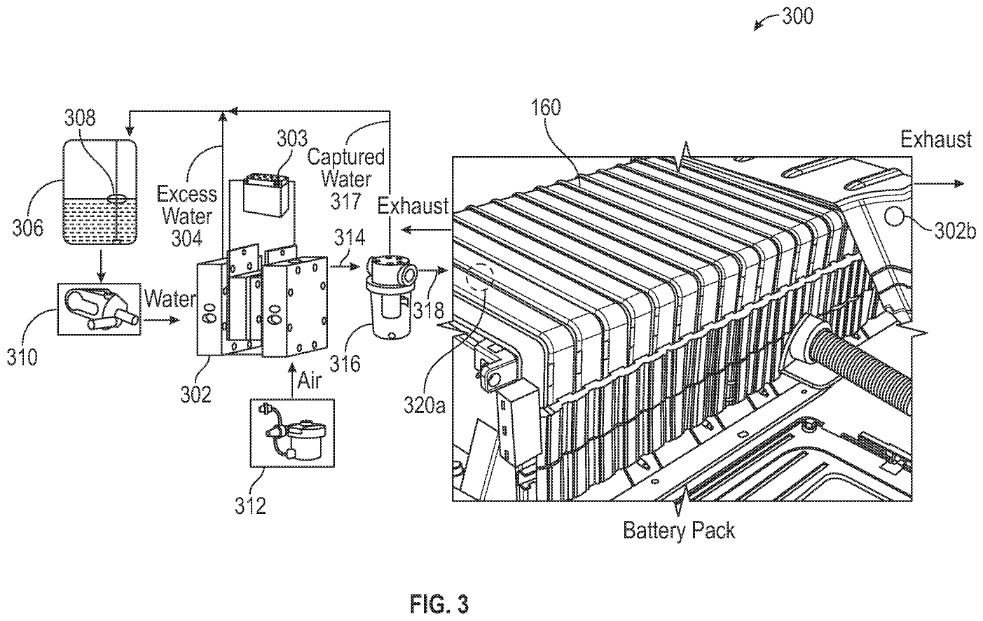

FIG. 3 is a more detailed block diagram of a fire-prevention system, according to certain illustrative embodiments of the present disclosure. Fire-prevention system 300 includes an ELBIS 302 as previously described. The amount of NEA will be determined by the needed flow rate for the size of the battery pack, and the size of the ELBIS will be sized for such flow rate. A buck converter is used to lower the voltage from 12V to such as 1.2V, for example, to achieve higher current to the ELBIS. In this example, ELBIS 302 is coupled to a voltage source 303 (e.g., 12V battery). In certain embodiments, a buck converter (12V to 1.2V, e.g.) is utilized for the electrolizer. Excess water 304 is generated by ELBIS 302 and captured inside water tank 306. The water level may also be monitored by a level sensor 308 (and, in certain embodiments, refilled during vehicle servicing). A water pump 310 is coupled to water tank 306 in order to extract water from tank 306 and recirculate it to ELBIS 302 was needed. Meanwhile, an air pump 312 supplies pressurized air to ELBIS 302 in order to generate humidified NEA 314. In certain embodiments, the air pump control for NEA will sync with the electrolyzer voltage for a target flow rate. A dehumidifier 316 (also referred to herein as a moisture separator or air dryer) receives humidified NEA 314, dries it, and outputs dehumidified NEA 318 which is supplied to battery pack 160. Dehumidifier 316 may take a variety of forms including, for example, a silicone membrane air dryer. The excess water 317 from dehumidifier 316 is captured and directed back to water tank 306, where it is also recirculated as previously described.

One or more oxygen sensors 320a and 320b are positioned adjacent the inlet and outlet of battery pack 160. Sensor 320b may be positioned inside or outside the battery pack 160, so long as it is positioned to sense the oxygen content of the air exiting battery pack 160. Sensor 320a may also be positioned inside or outside battery pack 160, so long as it is positioned to sense the oxygen content of the air as it enters battery pack 160. Although not shown, operational equipment engine 140 and vehicle control unit 110 (also referred to as “controller(s)”) are communicably coupled to fire-prevention system 200 and 300 in order to perform the operations described herein.

During operation, fire-prevention system 200/300 is passive until it detects (via sensors 320a,b) the oxygen content of the air inside battery pack 160 rises above a predetermined threshold. In certain embodiments, the predetermined threshold may be a 9% oxygen content or a 5% oxygen content. In yet other embodiments, the predetermined threshold may be a range of 5-9%. Nevertheless, once the controller determines the oxygen content of the air inside battery pack 160 has risen above this threshold, ELBIS 202/302 is activated to generate the NEA necessary to decrease the oxygen content of the air inside battery pack 160 back to or below the threshold. Once this occurs, fire-prevention system 200/300 goes back to passive mode while continuing to monitor the oxygen content of battery pack 160.

FIG. 4 is a flow chart of a fire-prevention method for an electric vehicle, according to certain illustrative methods of the present disclosure. In method 400, at block 402, the fire-prevention system detects an oxygen content of an electric vehicle battery pack using an oxygen sensor. At block 404, the system determines whether the oxygen content exceeds a predetermined threshold (e.g., a 5% oxygen content). At block 406, in response to the determination the oxygen content does exceed the threshold, the system then activates the ELBIS to generate NEA. At block 408, the system then delivers the NEA to the battery pack until the oxygen content no longer exceeds the predetermined threshold, thereby preventing a fire from being ignited within the battery pack.

In other illustrative embodiments, the fire-prevention system initiates the ELBIS when the vehicle is sitting in a hot environment for a predetermined period of time or when a predetermined temperature is reached inside the battery pack or under the hood. In other examples, the fire-prevention system may be activated when the vehicle is parked for a predetermined period of time.

In yet other embodiments, the size of the fire-prevention system may be small enough to be portable and retrofit to the battery packs. For example, the fire-prevention system may be 10×10×5 cm. Nevertheless, the size is based on the need of, for example, 5, 10, 15, 20, 25 or 30 L total volume of air in the battery pack and with a flow rate of 0.5L/min (or, e.g., 1, 1.5, 2 L/min). The exemplary 10×10×5 cm size is referenced to a 30 L and 2 L/min flow rate. The oxygen sensor is not included in this dimension. Other accessory such as pumps will be packed closely with the ELBIS and the size could be larger than 10×10×5 cm. In yet other embodiments, the fire-prevention system unit is a size sufficient to allow the optimal flow rate in the battery pack interior and fill the space while meeting the energy requirement for the flow rate.

In yet other embodiments, the controller monitors when the voltage supply energy is low and issues an alarm signal to the vehicle operator or otherwise (e.g., a third party monitor).

Although the examples described herein focus on vehicle applications, the fire-prevention system may also be used in other applications, as will be understood by those ordinarily skilled in the art.

Furthermore, the illustrative methodologies described herein may be implemented by a system comprising processing circuitry or a non-transitory computer program product comprising instructions which, when executed by at least one processor, causes the processor to perform any of the methodology described herein.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

In several example embodiments, while different steps, processes, and procedures are described as appearing as distinct acts, one or more of the steps, one or more of the processes, and/or one or more of the procedures may also be performed in different orders, simultaneously, and/or sequentially. In several example embodiments, the steps, processes and/or procedures may be merged into one or more steps, processes, and/or procedures.

Although various embodiments and methods have been shown and described, the disclosure is not limited to such embodiments and methods and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. A fire-prevention method for an electric vehicle, the method comprising:
detecting an oxygen content of an electric vehicle battery pack using an oxygen sensor;
determining the oxygen content exceeds a predetermined threshold;
in response to the determination, activating an electrochemical battery inerting system (“ELBIS”) to generate nitrogen-enriched air (“NEA”); and
delivering the NEA to the battery pack until the oxygen content no longer exceeds the predetermined threshold, thereby preventing a fire from being ignited within the battery pack.

2. The method as defined in claim 1, further comprising capturing and recirculating water vapor of the ELBIS using an air dryer, thereby dehumidifying the NEA before it is delivered to the battery pack.

3. The method as defined in claim 1, wherein the predetermined threshold is a 9% oxygen content.

4. The method as defined in claim 1, wherein the predetermined threshold is a 5% oxygen content.

5. The method as defined in claim 1, wherein the predetermined threshold is a 5-9% oxygen content.

6. The method as defined in claim 1, wherein the oxygen content is detected inside the battery pack near an inlet or outlet of the battery pack.

7. A fire-prevention system for an electric vehicle, the system comprising:
a controller;
an oxygen sensor, communicably coupled to the controller, to detect an oxygen content of an electric vehicle battery pack; and
an electrochemical battery inerting system (“ELBIS”) that generates nitrogen-enriched air (“NEA”) in response to a determination, by the controller, the oxygen content exceeds the predetermined threshold,
wherein the ELBIS continues to deliver the NEA to the battery pack until the oxygen content no longer exceeds the predetermined threshold, thereby preventing a fire from being ignited within the battery pack.

8. The system as defined in claim 7, further comprising an air dryer to capture and recirculate water vapor of the ELBIS, thereby dehumidifying the NEA before it is delivered to the battery pack.

9. The system as defined in claim 7, wherein the oxygen sensor is located near an inlet or outlet of the battery pack.

10. The system as defined in claim 7, wherein the predetermined threshold is a 9% oxygen content.

11. The system as defined in claim 7, wherein the predetermined threshold is a 5% oxygen content.

12. The system as defined in claim 7, wherein the predetermined threshold is a 5-9% oxygen content.

13. The system as defined in claim 7, wherein the system is portable and can be retrofit to the battery pack.

14. An electric vehicle, comprising:
a battery pack;
a controller;
an oxygen sensor, communicably coupled to the controller, to detect an oxygen content of the battery pack;
an electrochemical battery inerting system (“ELBIS”) that generates nitrogen-enriched air (“NEA”) in response to a determination, by the controller, the oxygen content exceeds the predetermined threshold,
wherein the ELBIS delivers the NEA to the battery pack until the oxygen content no longer exceeds the predetermined threshold, thereby preventing a fire from being ignited within the battery pack; and
air dryer to capture and recirculate water vapor of the ELBIS, thereby dehumidifying the NEA before it is delivered to the battery pack.

15. The electric vehicle as defined in claim 14, wherein the air dryer is a silicone membrane air dryer.

16. The electric vehicle as defined in claim 14, wherein the oxygen sensor is located near an inlet or outlet of the battery pack.

17. The electric vehicle as defined in claim 14, wherein the predetermined threshold is a 9% oxygen content.

18. The electric vehicle as defined in claim 14, wherein the predetermined threshold is a 5% oxygen content.

19. The electric vehicle as defined in claim 14, wherein the predetermined threshold is a 5-9% oxygen content.

20. The electric vehicle as defined in claim 14, wherein the ELBIS and the controller are retrofit to the battery pack.
